(19) United States
(12) Patent Application Publication
(10) Pub. No.: US 2016/0221539 A1
(43) Pub. Date: Aug. 4, 2016

(54) WIPER LIP FOR A WINDSHIELD WIPER DEVICE

(71) Applicant: ROBERT BOSCH GMBH, Stuttgart (DE)

(72) Inventors: Viktor Hackl, Sopron (HU); Peter Deak, Budapest (HU); Michael Weiler, Buehl (DE); Attila Geleta, Budapest (HU)

(21) Appl. No.: 14/917,311

(22) PCT Filed: Aug. 4, 2014
(86) PCT No.: PCT/EP2014/066725

§ 371 Date: Mar. 8, 2016

(30) Foreign Application Priority Data
Sep. 9, 2013 (DE) 102013217930.8

(51) Int. Cl. B60S 1/38

(52) U.S. Cl. CPC B60S 1/38; B60S 2001/3836; B60S 2001/3829; B60S 2001/3898

(57) ABSTRACT

The invention relates to a wiper lip (20) adapted to a windshield wiper device (20). The windshield wiper device (20) has an elongated, at least partially bendable upper part (10), an elongated, at least partially bendable lower part (12), and a plurality of connection elements (18) for connecting the upper part (10) and the lower part (12). The connection elements (18) are configured to allow a movement of the upper part (10) and of the lower part relative to one another with a movement component along a longitudinal extension (8) of the wiper blade (2). The wiper lip is configured such that the rigidity of the wiper lip in the wiper direction (1) is greater than the rigidity of the wiper lip vertical to the wiping direction.

### BACKGROUND OF THE INVENTION

The invention relates to a windshield wiper device for a vehicle, in particular a motor vehicle, furthermore in particular a wiper lip for a windshield wiper device.

Windshield wiper devices typically have a wiper arm or wiper lever, wherein a wiper blade to which a wiper lip is secured is moved on the windshield of a motor vehicle. The wiper arm is moved alternately between a first turning position and a second turning position. To this end, the wiper arm is connected to a wiper motor by means of the drive shaft. In particular on windshields with great changes of curvature, the wiper blade with the wiper lip easily loses contact with the windshield. In particular with highly curved windshields, this may lead to unwiped wiping regions or to the formation of haze.

In windshield wiper devices known from the prior art, during the reversal of the wiper arm in the turning positions, there is often a noise which, in particular depending on the motor vehicle and/or a driver situation of the motor vehicle, is found to be disruptive. This noise is in particular caused by the wiper lip being raised first when the movement direction of the wiper arm or the wiper blade is reversed, wherein the wiper arm is urged away from the windshield and subsequently folds over in the other direction. During the folding, the wiper arm together with the wiper blade is accelerated in the direction of the windshield. In this instance, the wiper blade moves in the direction of the windshield and is then abruptly braked. As a result of the acceleration and the braking, an impact is produced against the windshield, which causes the noise. There is therefore a requirement to further improve windshield wiper devices, in particular to prevent or at least reduce noises of the windshield wiper device.

### SUMMARY OF THE INVENTION

In the improvement of windshield wiper devices, there are a plurality of peripheral conditions which should be taken into account. These include the complexity in terms of the production or the production costs, the material costs, but also the properties of the windshield wiper device, in particular the function under a variety of conditions and the service-life under a large number of conditions. It should be taken into account for wiper devices for vehicles that the cost pressure constantly increases and that the vehicles can be used in a large number of climatic conditions so that, for example, extreme temperature values occur permanently and/or with large fluctuations.

An object of the present invention is to provide a wiper lip by means of which at least one or more of the above-mentioned disadvantages is/are reduced or substantially do/does not occur.

According to embodiments of the present invention, there is provided a wiper lip which is adapted to a windshield wiper device comprising a wiper blade with an elongate upper portion and an elongate lower portion, which are constructed so as to be at least partially bendable. Furthermore, the windshield wiper device to which the wiper lip is adapted has a plurality of connection elements which are for connecting the upper portion and the lower portion, and which are spaced apart from each other over a longitudinal extent of the wiper blade. Furthermore, the connection elements are configured to enable a movement of the upper portion and the lower portion relative to each other with a movement component over a longitudinal extent of the wiper blade. The windshield wiper device is adapted to a vehicle, in particular a motor vehicle. The wiper blade is configured so that the rigidity of the wiper lip is higher in the wiping direction than the rigidity of the wiper lip perpendicularly relative to the wiping direction.

According to another embodiment of the invention, a windshield wiper device is provided for a vehicle, in particular a motor vehicle. The windshield wiper device comprises an elongate upper portion which is constructed so as to be at least partially bendable, an elongate lower portion which is constructed to be at least partially bendable and a plurality of connection elements for connecting the upper portion and the lower portion. The connection elements are spaced apart from each other over a longitudinal extent of the wiper blade and configured in order to enable a movement of the upper portion and the lower portion relative to each other with a movement component over a longitudinal extent of the wiper blade. Furthermore, the windshield wiper device comprises a wiper lip according to the embodiments described herein.

Preferred embodiments and particular aspects of the invention will be appreciated from the dependent claims, the drawings and the present description.

According to the embodiments described herein, Fin-Ray windshield wiper devices can be produced for vehicle windshields in a particularly advantageous manner and/or can be produced for a plurality of different fields of application. The present embodiments of the windshield wiper device with the wiper lip according to the embodiments described herein enable a particularly good adaptation to the curvature of a windshield. This ensures particularly good and precise wiping of the windshield. Regions of the windshield which are not wiped and a formation of haze on the windshield can be extensively avoided. The structural configuration of the wiper lip described herein enables an extensively uniform pressing pressure of the wiper lip on the windshield so that a high wiping quality is provided and a noise, in particular with a reversal of the movement direction of the wiper arm or the wiper blade in a turning position is prevented or at least reduced.

According to embodiments of the disclosure which can be combined with other embodiments described herein, the wiper lip comprises a base region and a wiper region, wherein the base region is configured, when the wiper lip comes into contact with a windshield and the spacing between the wiper blade and the windshield is reduced, to provide a constant pressing force which acts substantially perpendicularly relative to the wiping direction. Consequently, a folding-over of the wiper lip, as known from the prior art, can be reduced or substantially prevented and a noise, in particular in the event of a reversal of the movement direction of the wiper arm or the wiper blade in a turning position can be reduced.

According to embodiments of the disclosure which can be combined with other embodiments described herein, the wiper region has a pointed end and a wide end, wherein a wiper edge is arranged at the pointed end of the wiper region, wherein the base region of the wiper lip is arranged at the wide end of the wiper region, and wherein the base region of the wiper lip is wider than the wide end of the wiper region. It is thereby possible for a wiper lip to be provided which has a higher rigidity in the wiping direction than perpendicularly relative to the wiping direction, whereby a folding-over of the wiper lip, as known from the prior art, can be reduced or can be substantially prevented.

According to embodiments of the disclosure which can be combined with other embodiments described herein, the base region of the wiper lip has a recess, wherein the recess is arranged above the wide end of the wiper region. Via the sizing of the recess, a constant pressing pressure can be adjusted between the wiper lip and the windshield.

According to embodiments of the disclosure which can be combined with other embodiments described herein, the width of the recess in the base region of the wiper lip is greater than the width of the wide end of the wiper region. Via the relationship of the width B_{W} of the wide end of the wiper region with respect to the width of the recess in the base region, the pressing pressure between the wiper lip and windshield can be adjusted.

According to embodiments of the disclosure which can be combined with other embodiments described herein, the wiper edge of the wiper lip comprises an angle of from 60° to 120°, in particular 90°. Consequently, a wiper lip with a particularly high wiping quality is provided.

According to embodiments of the disclosure which can be combined with other embodiments described herein, the recess comprises a depth of from 1 mm to 3 mm. Via the depth of the recess, the pressing pressure between the wiper lip and the windshield can be adjusted.

According to embodiments of the disclosure which can be combined with other embodiments described herein, the wiper lip is of a material from the group comprising: TPE (thermoplastic elastomer), in particular TPE-S, TPE-O, TPE-U, TPE-A, TPE-V, TPE-E; ethylene-propylene-diene rubber (EPDM); polychloroprene and natural rubber. The material selection of the wiper lip enables the adjustment of the physical properties of the wiper lip and further enables production with the injection-molding method, in particular with a dual component injection-molding method.

According to embodiments of the disclosure which can be combined with other embodiments described herein, the base region is formed from a first material and the wiper region is formed from a second material. Consequently, a wiper lip which is optimized in terms of its functional material properties can be provided.

According to embodiments of the disclosure which can be combined with other embodiments described herein, the wiper lip is produced by means of an extrusion method or an injection-molding method, in particular a dual component injection-molding method. A wiper lip which is cost-effective and simple to produce is thereby provided.

### BRIEF DESCRIPTION OF THE DRAWINGS

Embodiments of the invention are illustrated in the Figures and are described in greater detail below. In the drawings:

FIG. 1 is a schematic illustration of a wiper lip according to embodiments of the disclosure,

FIG. 2A is a schematic illustration of a wiper lip according to embodiments of the disclosure,

FIG. 2B is a schematic illustration of a wiper lip according to embodiments of the disclosure,

FIG. 3A is a schematic illustration of a wiper lip according to embodiments of the disclosure,

FIG. 3B is a schematic illustration of a wiper lip according to embodiments of the disclosure,

FIG. 4 is a perspective illustration of an end of a windshield wiper device according to embodiments of the disclosure with a wiper lip according to embodiments of the disclosure,

FIG. 5 is a schematic pressure line of a wiper lip according to embodiments of the disclosure with a load which is perpendicular relative to the wiping direction,

FIG. 6A is a schematic illustration of a wiper blade of a windshield wiper device according to embodiments of the disclosure in a basic position,

FIG. 6B is a schematic illustration of the wiper blade of a windshield wiper device according to embodiments of the disclosure according to FIG. 4A in a position placed on a windshield,

FIG. 7A is a schematic illustration of another embodiment of a windshield wiper device according to the invention in the form of a wiper arm with integrated wiper blade in a basic position,

FIG. 7B is a schematic illustration of the wiper arm with integrated wiper blade according to FIG. 7A in a position placed on a windshield,

FIG. 8 is a schematic, perspective view of a wiper arm of a windshield wiper device according to embodiments of the disclosure,

FIG. 9A is a schematic illustration of a cut-out of the wiper blade according to FIG. 7A,

FIG. 9B is a schematic illustration of a cut-out of the wiper blade according to FIG. 7B.

### DETAILED DESCRIPTION

Unless otherwise indicated, the same reference numerals are used below for elements which are the same and which have the same effect.

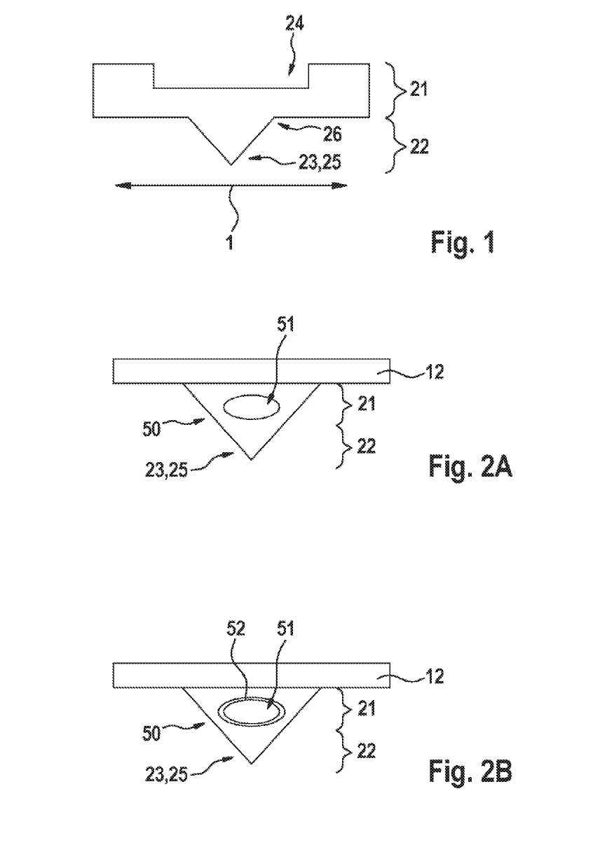

FIG. 1 is a schematic illustration of a wiper lip 50 according to embodiments of the disclosure. The wiper lip 50 is adapted to a windshield wiper device 100 which is described herein. According to embodiments of the disclosure, the wiper lip 50 is configured so that the rigidity of the wiper lip 50 in the wiping direction 1 is higher than the rigidity of the wiper lip 50 perpendicularly relative to the wiping direction 1. There is thereby produced a wiper lip which has a high level of wiping quality and by means of which a noise is reduced, in particular when the movement direction of the wiper arm or the wiper blade is reversed in a turning position.

According to typical embodiments of the wiper lip 50, as illustrated by way of example in FIG. 1, the wiper lip 50 comprises a base region 21 and a wiping region 22. Typically, the base region 21 is configured to provide a constant pressing force which acts perpendicularly relative to the wiping direction 1 in the event of contact of the wiper lip 50 with a windshield. There is thereby produced a wiper lip which has a high level of wiping quality and by means of which a noise is reduced, in particular when the movement direction of the wiper arm or the wiper blade is reversed in a turning position.

As illustrated by way of example in FIG. 1, the wiping region 22 of the wiper lip 50 according to embodiments of the disclosure has a pointed end 25 and a wide end 26. At the pointed end 25 of the wiper region 22, there is typically arranged a wiping edge 23 which is typically in contact with the windshield to be wiped. According to embodiments of the disclosure, the wiper edge 23 is configured to provide a friction coefficient between the wiper lip and the windshield of a motor vehicle, in particular in a wet state of the windshield, of a maximum of 0.2, in particular a maximum of 0.1, in particular a maximum of 0.05.

According to embodiments described herein, the base region 21 of the wiper lip 50 is typically arranged at the wide end 26 of the wiping region 22. As illustrated by way of example in FIG. 1, the base region 21 of the wiper lip 50 is wider than the wide end 26 of the wiper region 22. A wiper lip is thereby provided in which the rigidity of the wiper lip is higher in the wiping direction than the rigidity of the wiper lip perpendicularly relative to the wiping direction. Consequently, a folding-over of the wiper lip, as known from the prior art, can be reduced or substantially prevented and a noise, in particular when the movement direction of the wiper arm or the wiper blade is reversed in a turning position can be reduced.

According to typical embodiments of the wiper lip, which can be combined with other embodiments, the wiper edge 23 comprises an angle α of from 60° to 120°, in particular 90°. A wiper lip with a good sealing action between the wiper lip and the windshield and a high wiping quality is thereby provided.

As shown by way of example in FIG. 1, the base region 21 of the wiper lip 20 according to embodiments described herein has a recess 24. Typically, the recess 24 is arranged above the wide end 26 of the wiping region 22. Typically, the wiping region 22 is arranged centrally relative to the recess 24 of the base region 21.

According to embodiments of the wiper lip which can be combined with other embodiments, the recess 24 has a width B_{A} of at least 6 mm, in particular of at least 7 mm, in particular of at least 8 mm. Typically, the width B_{W} of the wide end 26 of the wiping region 22 is smaller than the width B_{A} of the recess 24. According to typical embodiments of the wiper lip, the width B_{A} of the recess 24 and the width B_{W} of the wide end 26 of the wiping region 22 is selected in such a manner that a ratio of B_{W}/B_{A} is a maximum of 0.8, in particular a maximum of 0.7, in particular a maximum of 0.6.

According to embodiments of the wiper lip which can be combined with other embodiments, the base region 21 has a width B_{B} of at least 10 mm, in particular at least 12 mm, in particular at least 15 mm.

According to embodiments of the wiper lip which can be combined with other embodiments, the recess 24 has a depth T_{A} of at least 1 mm, in particular at least 2 mm, in particular at least 3 mm. As explained in greater detail with reference to FIG. 5, as a result of the sizing of the depth T_{A} of the recess 24 in the base region 21 of the wiper lip, the spacing region between the wiper blade and windshield, in which a substantially constant pressing pressure is present between the wiper lip and windshield can be adjusted. In this instance, with an increase of the depth T_{A} of the recess 24, the spacing region between the wiper blade and the windshield at which a substantially constant pressing pressure acts between the wiper blade and the windshield can be increased.

According to typical embodiments of the wiper lip, the height H_{B} of the base region 21 and the depth T_{A} of the recess 24 is selected in such a manner that a ratio of T_{A}/H_{B} is a maximum of 0.8, in particular a maximum of 0.7, in particular a maximum of 0.6.

According to typical embodiments of the wiper lip which can be combined with other embodiments, the wiper lip may be produced from one or more materials from the group comprising: TPE (thermoplastic elastomer), for example, TPE-S, TPE-O, TPE-U, TPE-A, TPE-V, TPE-E; ethylene-propylene-diene rubber (EPDM); polychloroprene and natural rubber.

According to typical embodiments of the wiper lip which can be combined with other embodiments, the same material can be selected for the base region 21 of the wiper lip as for the wiping region 22 of the wiper lip. According to embodiments which are described herein, different materials can be selected for the base region 21 of the wiper lip and the wiper region 22 of the wiper lip. The base region 21 of the wiper lip may be produced from a first material from a group comprising: thermoplastic elastomer, for example, TPE-S, TPE-O, TPE-U, TPE-A, TPE-V, TPE-E; ethylene-propylene-diene rubber (EPDM); polychloroprene and natural rubber. The wiping region 22 of the wiper lip may be produced from a second material from a group comprising: thermoplastic elastomer, for example, TPE-S, TPE-O, TPE-U, TPE-A, TPE-V, TPE-E; ethylene-propylene-diene rubber (EPDM); polychloroprene and natural rubber. As a result of a material selection for the base region and for the wiping region, as a result of the respective material properties, the mechanical properties of the base region and the wiper region of the wiper lip can be adjusted.

Typically, the wiper lip according to embodiments of the present disclosure is produced by means of an extrusion method or an injection-molding method, in particular a dual component injection-molding method. The wiper lip can thereby be produced in a simple and cost-effective manner. The production of the wiper lip which is described herein by means of an extrusion method is particularly advantageous when ethylene-propylene-diene rubber (EPDM), polychloroprene or natural rubber is used.

According to embodiments of the wiper lip which can be combined with other embodiments, the wiper lip 50 has a hollow space 51, as illustrated by way of example in FIG. 2A. Typically, the hollow space 51 is configured in a tubular manner and extends in the longitudinal direction of the wiper lip. The ends of the tubular hollow space may be open, in particular air-permeable, or closed, in particular air-tight. The tubular hollow space may have a circular, an oval, a triangular, a rectangular or other suitable cross-sections. According to embodiments, the tubular hollow space is arranged in the base region 21 of the wiper lip. Via the sizing of the hollow space and the selection of the cross-section of the hollow space, the rigidity of the wiper lip can be adjusted. In particular the rigidity of the wiper lip can be adjusted in such a manner that a folding-over of the wiper lip, as known from the prior art, can be reduced or substantially avoided. Consequently, a wiper lip is provided by means of which a noise, in particular when the movement direction of the wiper arm or the wiper blade is reversed in a turning position, can be reduced.

According to embodiments of the wiper lip which can be combined with other embodiments, the hollow space 51 has an inner coating 52, as illustrated by way of example in FIG. 2B. According to embodiments of the wiper lip, the hollow space 51 is completely filled with the coating 52. The coating 52 may be of a different material from that of the wiper lip. In particular it is possible to select for the coating 52 of the hollow space 51 a material which has a different rigidity from the material of the wiper lip. For example, in comparison with the material of the wiper lip for the coating, a material with a higher or lower rigidity can be selected. Consequently, a wiper lip is provided in which, on the one hand, via the material selection of the coating and via the thickness of the coating, the rigidity of the wiper lip can be adjusted.

According to embodiments of the wiper lip which can be combined with other embodiments, the base region 21 of the wiper lip 50 is configured in such a manner that the base region 21 can be lowered into a recess of a lower portion 12 of a windshield wiper device. According to embodiments, the base region 21 may have at least one indentation which is arranged in such a manner that, via the sizing of the at least one indentation, the rigidity of the wiper lip, in particular the rigidity of the wiper lip perpendicularly relative to the wiping direction, can be adjusted.

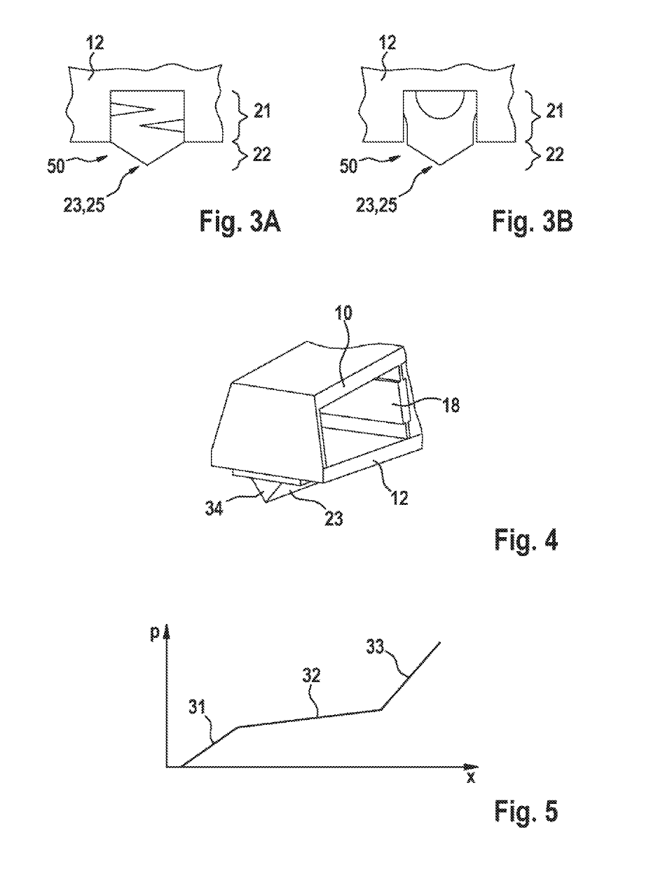

According to embodiments, the at least one indentation is arranged at an end of the base region 21 which is opposite the wiping region 22, in particular the wiper edge 23, as illustrated by way of example in FIG. 3B. Furthermore, the wiper lip according to embodiments may be configured in such a manner that, after assembly of the wiper lip on a lower portion of a wiper blade by means of introduction of the base region 21 of the wiper lip 50 in a recess of the lower portion 12, the wiper lip is only partially in contact with the wall of the recess of the lower portion. In particular, the wiper lip 50 may be configured in such a manner that a play is present after assembly of the wiper lip on a lower portion of a wiper blade, between the lateral regions of the base region 21 of the wiper lip at the end of the wiping region and the recess of the lower portion. Consequently, a wiper lip is provided which has a higher rigidity in the wiping direction than perpendicularly to the wiping direction. Consequently, there can be provided a wiper lip by means of which a noise, in particular when the movement direction of the wiper arm or the wiper blade is reversed in a turning position, can be reduced.

According to embodiments which can be combined with other embodiments, the at least one indentation is arranged laterally on the base region 21 of the wiper lip. As illustrated by way of example in FIG. 3A, according to embodiments at least two lateral recesses are arranged on the base region in such a manner that they face each other, in particular face each other in an offset manner. Via the sizing, the number and arrangement of the lateral indentations in the base region of the wiper lip, the rigidity of the wiper lip, in particular the rigidity of the wiper lip perpendicularly relative to the wiping direction, can be adjusted. It is thereby possible to provide a wiper lip by means of which a noise, in particular when the movement direction of the wiper arm or the wiper blade is reversed in a turning position, can be reduced. Also in FIG. 3A, the wiper lip is introduced into a recess of the lower portion. For these embodiments, as shown by way of example in FIGS. 3A and 3B, the wiper lip can be adhesively bonded or axially fixed in another manner. This may be provided, for example, by an undercut portion or another shaping of the recess and a corresponding shaping of the wiper lip.

FIG. 4 is a perspective illustration of an exemplary wiper blade end of a windshield wiper device according to the embodiments described herein. As illustrated by way of example in FIG. 4, the wiper lip 50 is typically provided on the lower portion 12 of the wiper blade 2. According to embodiments, the wiper lip may comprise the same material as the wiper blade. Alternatively, the lip may comprise a different material from the wiper blade.

According to embodiments of the disclosure, the wiper lip may be constructed integrally with the lower portion 12 of the wiper blade 2. In this instance, the wiper lip and the lower portion of the wiper blade may at least partially comprise the same material. Alternatively, according to embodiments described herein, a receiving member may be provided on the lower portion 12 of the wiper blade so that the wiper lip 50 can be introduced. This affords the advantage that the wiper lip can be replaced separately and consequently, in contrast to replacing the entire wiper blade, a material saving is possible. According to another alternative, the wiper lip may be cold-welded to the lower portion of the wiper blade.

FIG. 5 illustrates by way of example a schematic pressure line for a wiper lip according to embodiments of the disclosure with a load which is perpendicular relative to the wiping direction. In this instance, the pressing pressure P between the wiper lip and windshield is applied when the spacing is reduced between the wiper blade and windshield. In FIG. 5, an increase of the x value means a reduction of the spacing between the wiper blade and windshield. As illustrated in FIG. 5, a pressing pressure line of the wiper lip according to the embodiments has a first region 31, a second region 32 and a third region 33. The first region 31 of the pressing pressure line describes the initial pressure increase, which occurs when the wiper lip comes into contact with the windshield. The second region 32 of the pressing pressure line describes the pressure path of the wiper lip during another reduction of the spacing between the wiper blade and windshield. As illustrated by way of example in FIG. 5, the pressing pressure in the second region 32 of the pressure line of the wiper lip is substantially constant or increases only slightly so that, for a specific spacing region between the wiper blade and windshield, that is to say, the length of the second region 32 of the pressure line, a substantially constant pressing pressure is present between the wiper lip and windshield. The third region 33 of the pressure line describes the pressing pressure of the wiper lip when the base of the recess 24 of the base region 21 comes into contact with the lower portion 12 of the wiper blade 2.

As already explained, via the sizing of the depth of the recess 24 in the base region 21 of the wiper lip, the spacing region between the lower portion 12 of the wiper blade 2 and the windshield, in which a substantially constant pressing force is present between the wiper lip and the windshield, can be adjusted. This means that the second region 32 of the pressing pressure line which is illustrated in FIG. 5 is extended as the depth of the recess 24, in which a substantially constant pressing pressure is present, increases.

There is described below an exemplary windshield wiper device, for which the wiper lip described herein can be used. In principle, however, the wiper lip described herein can also be used for other windshield wiper devices.

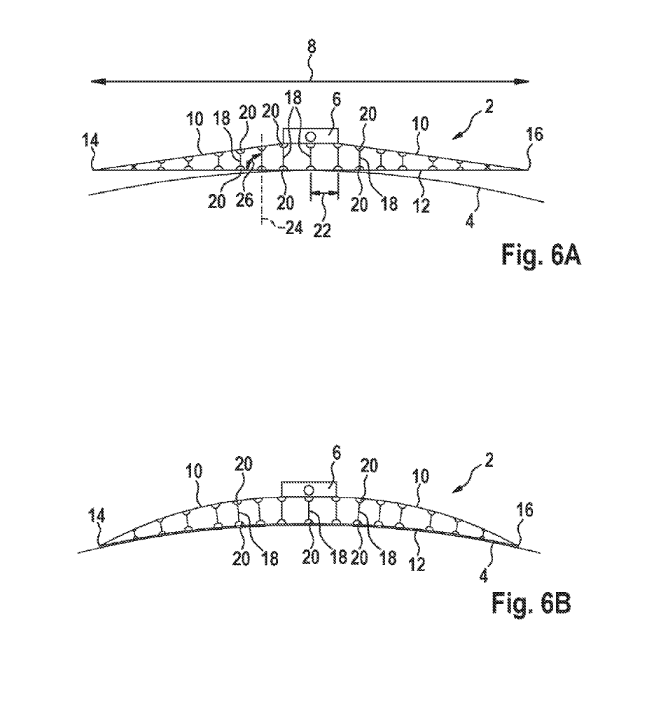

FIGS. 6A and 6B are schematic illustrations of a wiper blade 2 in a basic position (FIG. 6A) and in a position placed on a windshield (FIG. 6B) according to embodiments of the windshield wiper device of the disclosure. The wiper blade 2 serves to wipe a windshield 4 of a vehicle, which is, for example, a motor vehicle, in particular a car. Generally, the wiper blade 2 is fitted to a windshield wiper arm which is driven for wiping by means of a motor. To this end, the wiper blade 2 has a retention member 6, with which it can be secured to the windshield wiper arm. The wiper blade 2 is located in FIG. 6A in a basic position in which it is at least partially raised from the windshield 4. The wiper blade 2 has a longitudinal extent 8 and has an elongate upper portion 10 and a similarly elongate lower portion 12. The longitudinal extent of the upper portion 10 and the lower portion 12 substantially correspond to the longitudinal extent 8 of the wiper blade 2.

Both the upper portion 10 and the lower portion 12 are bendable bars or may be constructed as bendable bars which are constructed in FIGS. 6A and 6B by way of example in one piece in each case. This enables a particularly stable construction. It is also possible for only a portion of the upper portion 10 and/or the lower portion 12 to be constructed so as to be bendable. Furthermore, it is alternatively possible for the upper portion 10 to be constructed in two parts, wherein a respective end of the two portions of the two-part upper portion 10 are then secured to the retention member 6.

According to some embodiments, which can be combined with the other embodiments described herein, for the upper portion 10 and/or the lower portion 12 there is used a material which has an elasticity modulus which is in a range between 0.005 kN/mm² and 0.5 kN/mm², in particular 0.01 kN/mm² and 0.1 kN/mm². This enables a suitable flexibility of the upper portion 10 and the lower portion 12. Together with a suitably constructed cross-section face of the upper portion 10 and the lower portion 12, an optimum flexural strength is thus produced. The upper portion 10 and the lower portion 12 are thus arranged in such a manner that they face each other. Both ends of the upper portion 10 are securely connected at outer connection positions 14 and 16 to an end of the lower portion 12, respectively. Otherwise, the upper portion 10 and the lower portion 12 are spaced apart from each other.

The upper portion 10 and the lower portion 12 are connected to each other by means of connection elements 18. In particular in the basic position of the wiper blade 2, they extend substantially transversely relative to the longitudinal extent 8 of the wiper blade 2. The connection elements 18 are secured at mutually facing inner longitudinal sides of the upper portion 10 and the lower portion 12 by means of pivot joints 20. The pivot joints 20 are in this instance hinges. In particular, the pivot joints 20 may be constructed as film hinges. This is particularly advantageous when the upper portion 10, lower portion 12 and/or connection elements 18 are produced from a plastics material or are covered with a suitable plastics material.

According to typical embodiments which are described herein and which can be combined with other embodiments described herein, a pivot joint is selected from the following group which comprises: a hinge, a film hinge, a tapering of the material for producing lower rigidity in accordance with a torsion axis, a joint with a rotation axis, a means for connecting the upper portion to the connection element or for connecting the lower portion to the connection element which permits the displacement of the lower portion with respect to the upper portion over the longitudinal extent, etcetera.

Embodiments in which the joint is provided by means of a film hinge consequently provide a very simple manner of providing the joints for a Fin-Ray wiper. The wiper blade 2 can be provided in one piece, in particular in an off-tool manner. According to typical embodiments, the film hinges have a high expandability. This may, for example, be provided by a material selected from the group PP, PE, POM and PA. Alternatively, the film hinges may be produced from one or more materials from a group comprising: TPE (thermoplastic elastomer), for example, TPE-S, TPE-O, TPE-U, TPE-A, TPE-V and TPE-E.

The connection elements 18 are spaced apart from each other over the longitudinal extent of the wiper blade 2. The spacings between two adjacent connection elements 18 are the same. However, they may also be selected to be different. The spacings are advantageously smaller than 50 mm, in particular smaller than 30 mm. It is thereby possible to ensure particularly high flexibility of the windshield wiper device, in particular the lower portion thereof, and good adaptation to the curvature and curvature changes of the windshield to be wiped. In FIG. 6A in place of the spacings between two connection elements 18 in each case, a spacing 22 is illustrated. The connection elements 18 are, in particular in the basic position of the wiper blade 2, secured to the lower portion 12 in such a manner that the longitudinal axes thereof extend at angles 26 with respect to the lower portion 12 which are between 65° and 115°, in particular between 75° and 105°. In a particularly advantageous manner, the angles are between 80° and 100°. This advantageously ensures a particularly good transmission of a force acting on the lower portion to the upper portion. It is further possible in this manner to achieve a particularly stable windshield wiper device. The same applies to the fixing means of the connection elements 18 to the upper portion 10.

The same applies in the present embodiment to the fixing means of the connection elements 18 to the upper portion 10.

FIG. 6A illustrates by way of example of the longitudinal axes of the connection elements 18 a longitudinal axis 24 and by way of example of the angles between the connection elements 18 and the lower portion 12 an angle 26. The spacings between the upper portion 10 and the lower portion 12 are determined above all by the lengths of the connection elements 18. The lengths of the connection elements 18 increase starting from the two outer connection positions 14, 16 as far as approximately those locations at which the retention member 6 which is fitted to the upper portion 10 begins. The upper portion 10 and lower portion 12 thereby form in the side view of the wiper blade 2 according to FIG. 6A a double-wedge, wherein the tips of the two wedges face in opposing directions. The connection elements 18 are constructed in a buckle-resistant manner.

FIG. 6B is a schematic illustration of the wiper blade 2 according to FIG. 6A in a position placed on the windshield 4. Since the windshield 4 has a curvature, when the wiper blade 2 is placed on the windshield 4, contact pressure forces act on the lower portion 12. Since the upper portion 10 and the lower portion 12 are bendable bars and the connection elements 12 are rotatably supported on the upper portion 10 and lower portion 12, the upper portion 10 and the lower portion 12 can be displaced relative to each other. As a result of the pressure forces acting from below on the lower portion 12, the wiper blade 2 bends in the direction from which the pressure forces originate and is applied precisely with respect to the curvature of the windshield 4.

As a result of the structure of the embodiments described herein, when a force acts on the lower portion (as a result of the windshield 4), there is a bending of the lower portion in the direction from which the force acts. This is produced by means of the connection of the upper portion 10 and the lower portion at a connection position 14 and/or 16, the shape and pivot joints at the connection between the connection elements and the upper or lower portion.

In the illustration according to FIG. 6B, there is provided between the wiper blade 2 and the windshield 4 a small spacing which serves in this instance only to explain the windshield 4 and the wiper blade 2 and which in reality is substantially not present in this manner when the wiper blade 2 is placed on the windshield 4. Furthermore, there is typically at the lower side of the lower portion 12 facing away from the upper portion 10 a wiper lip 50 according to the embodiments described herein, as illustrated by way of example in FIG. 1, which is placed for wiping on the windshield 4. For reasons of clarity, the wiper lip is not illustrated in FIGS. 6A and 6B.

A windshield wiper device according to embodiments described herein uses the effect of tail fins of specific fish, which in the event of lateral pressure do not deviate in the pressure direction, but instead curve in the opposite direction, that is to say, in the direction from which the pressure originates. This principle is also referred to as the “fin ray” principle. A windshield wiper device according to the embodiments described herein thereby has the advantage of improved adaptation to a windshield of a motor vehicle. With a conventional windshield wiper blade, the upper portion thereof is generally rigid, that is to say, it is constructed so as not to be bendable.

FIGS. 6A and 6B show a wiper blade 2 with a longitudinal extent 8 which extends substantially between the connection positions 14 and 16. Such an arrangement is often used for front windshield wipers. Alternatively, however, a windshield wiper device may also have only one connection position which, by analogy with FIGS. 6A and 6B corresponds to a halving of the windshield wiper device, and wherein, for example, at a position of the retention member 6 a rotation axis is provided. Such an arrangement is often used for rear windshield wipers. This is illustrated by way of example inter alia in

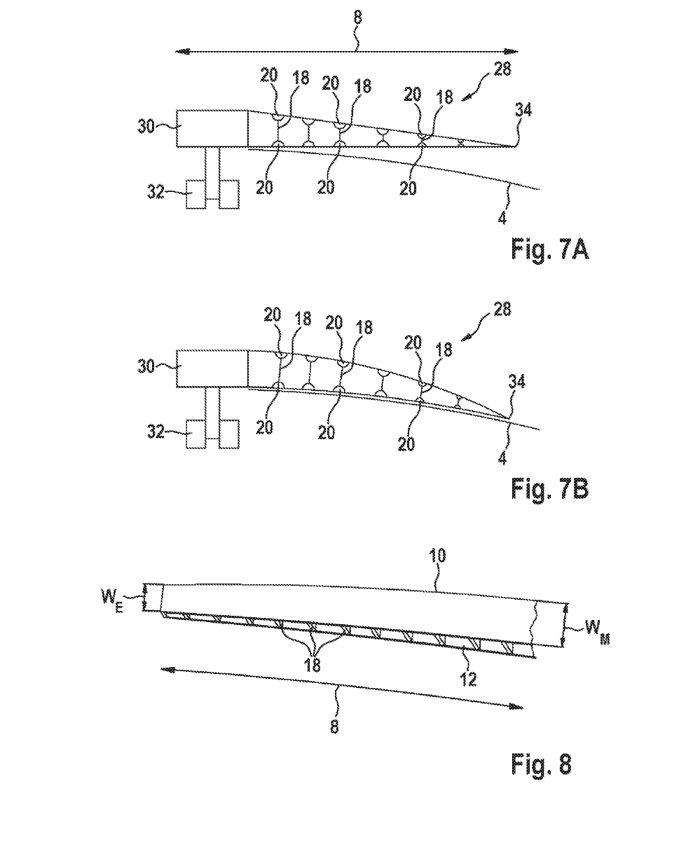

FIGS. 7A and 7B. Optional embodiments and details, as described in the individual embodiments, can generally be used for both variants of an arrangement of a windshield wiper device.

FIG. 7A is a schematic illustration of another embodiment of the windshield wiper device according to the invention in the basic position. The windshield wiper device is in this instance a wiper arm with an integrated wiper blade 2, which is fitted to a securing portion 30. The securing portion 30 is connected to a wiper motor 32 which drives the securing portion 30 for wiping the windshield 4. The wiper blade 2 is constructed in a wedge-shaped manner, wherein an end of the upper portion 10 at an outer connection position 34 is securely connected to an end of the lower portion 12. The other end of the upper portion 10 and the lower portion 12 is secured to the securing portion 30, respectively. With regard to the basic structure and in particular the securing means of the connection elements 18, the windshield wiper device according to FIG. 7A in principle corresponds to the one according to FIG. 6A.

FIG. 7B is a schematic illustration of the wiper blade 2 with integrated wiper arm 30 according to FIG. 7B in a position placed on the windshield 4. Also in this instance, pressure forces act from below from the direction of the windshield 4 on the lower portion 12 of the wiper blade 2 so that the lower portion 12 and the upper portion 10 bend in the direction of the windshield 4.

Both in FIG. 6A and in FIG. 7A, the wiper blade is illustrated in the position thereof not placed on the windshield in such a manner that the lower portion 12 is constructed in a substantially straight manner. According to other embodiments which can be combined with other embodiments, the lower portion is constructed in a convex manner in the unloaded state, that is to say, with a curvature which protrudes away from the upper portion in a central region. The windshield wiper device according to the embodiments described herein can typically, in the event of contact with a windshield, starting from the convex shape of the lower portion, then assume the corresponding concave shape of the lower portion, which is adapted to the windshield.

FIG. 8 is a schematic, perspective illustration of a wiper blade 2 of a windshield wiper device according to embodiments of the disclosure. As illustrated in FIG. 8, the wiper blade 2 has at the outer connection positions, at which the ends of the elongate upper portion 10 and the lower portion 12 are connected to each other, an outer width W_{E}. According to typical embodiments, the outer width W_{E} is at least 15 mm, in particular at least 20 mm, in particular at least 25 mm.

According to embodiments of the disclosure which can be combined with other embodiments, the width of the wiper blade 2 increases from the outer connection positions in the direction of the securing portion 30 or the retention member 6 to which the wiper blade on the windshield wiper arm can be secured. In FIG. 8, an inner width is designated W_{M} by way of example. According to typical embodiments, the inner width W_{M} is at least 20 mm, in particular at least 25 mm, in particular at least 30 mm.

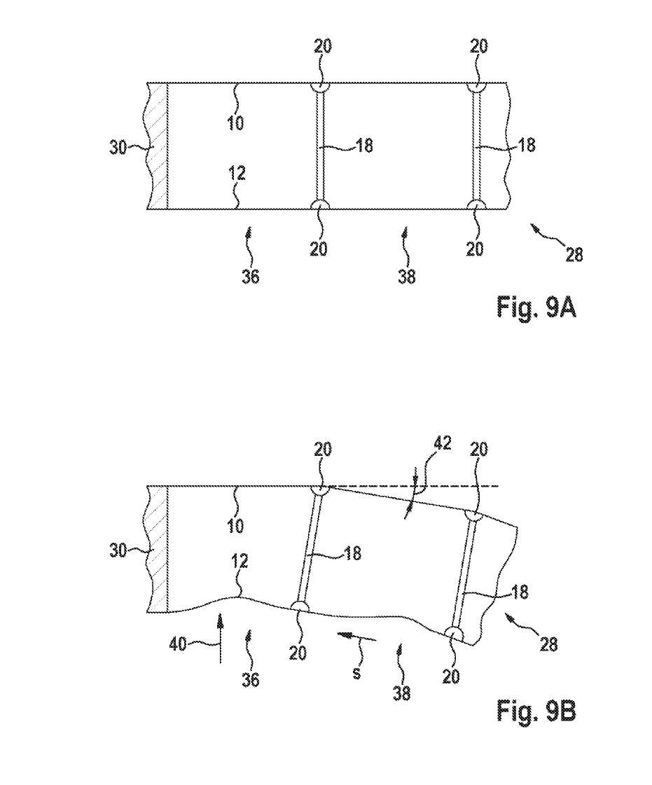

FIG. 9A is a schematic illustration of a cut-out of the wiper blade 2 according to the embodiment according to FIG. 7A in which the wiper blade 2 is located in the basic position. The left end region of the wiper blade 2 in which an end of the upper portion 10 and an end of the lower portion 12 are secured to the securing portion 30 is illustrated. FIG. 9A shows starting from the transition from the securing portion 30 to the wiper blade 2 the first two connection elements 18 which delimit two wiper blade elements 36 and 38. The connection elements 18 are secured to the upper portion 10 and the lower portion 12 by means of pivot joints 20.

FIG. 9B is a schematic illustration of a cut-out of the wiper blade 2 according to the embodiment according to FIG. 7B, in which the wiper blade 2 is placed on the windshield 4. Pressure forces act on the lower portion 12 from below from the direction of the windshield. In place of the pressure forces, a pressure force 40 is illustrated in FIG. 9B. The pressure force 40 brings about a curvature and bending of the lower portion 12 of the wiper blade element 36. The pivot joint 20 of the first connection element 18 is thereby displaced by a distance s to the left. The second wiper blade element 38 bends downward in the direction from which the pressure force 40 originates and fits closely against the windshield. An angle 42 is produced in this case between the first wiper blade element 36 and the second wiper blade element 38. There is further formed an additional pressure force which then acts on the lower portion 12 of the second wiper blade element 38 and prevents further bending of the second wiper blade element 38 in a downward direction. A chain reaction is produced with respect to the right-hand adjacent wiper blade element as far as the end of the wiper blade 2.

According to embodiments of the disclosure, on the lower portion 12 of the wiper blade 2, for example, on wiper blades as illustrated by way of example in FIGS. 6A, 6B, 7A and 7B, a wiper lip 50 according to the embodiments described herein is provided. The wiper lip 50 wipes over the windshield of the vehicle in order to clean it. With off-tool wiper blades, this may be provided integrally in a preferred embodiment.

According to another embodiment, in order to produce a wiper lip and a wiper blade in a cost-effective and economical manner, the lower portion 12, or, for the entire wiper blade 2, also the upper portion 10, and the connection elements 18, is produced from a first material. Typically, this may be the same material or different materials can also be selected for the individual components. These materials may be selected from a group comprising: TPE (thermoplastic elastomer), TPE-S, TPE-O, TPE-U, TPE-A, TPE-V and TPE-E, wherein materials which are cost-effective to obtain or which can be produced in a cost-effective manner can be used.

The wiper lip 50 and the joint 20 on the lower portion 12 may be produced from a different material which complies with the increased requirements with respect to flexural rigidity, creep resistance or other requirements. Since, with such an embodiment of a joint for a wiper blade or a wiper lip for a wiper blade, only a limited material requirement for the joint and the wiper lip exists, higher quality (and more costly) materials can be used, without excessively increasing the overall costs of the wiper blade.

It is possible to construct a rigid or relatively rigid rib or a rigid connection element, the lower portion and the upper portion from a plastics material. This may, for example, be a fiber-reinforced plastics material. The joint 20 and the rubber profile of the wiper lip 50 are produced from a rubber-like material. The two different materials may, for example, be provided in a 2-component injection-molding method. According to typical embodiments, it is possible to use as a rubber-like material a thermoplastic elastomer (TPE), for example, TPE-S, TPE-O, TPE-U, TPE-A, TPE-V and TPE-E; ethylene-propylene-diene rubber (EPDM); polychloroprene or natural rubber.

Optionally, the TPE joint can be provided independently of the wiper rubber profile, that is to say, the wiper lip. However, in the same injection-molding tool, the rubber profile of the wiper lip and/or, for example, also a styling of the surface can also be produced. By means of such a reduction of the injection-molding tools, the production costs can be reduced.

According to the embodiments described herein, materials can be selected so as to enable, even with high temperature fluctuations and/or with consistently high ambient temperatures, a reliable or durable windshield wiper device. The material selection of the film hinges, in particular together with the thickness of the hinges, enables flexural rigidity at a predetermined value or below and further enables production using the injection-molding method, with corresponding properties of the wiper blade, for example, an adequate creep resistance of the pivot joints.

According to the embodiments described herein, Fin-Ray windshield wiper devices for vehicle windshields can be produced in a particularly cost-effective manner and/or for a plurality of different fields of application. The present embodiments of the windshield wiper device with the wiper lip according to the embodiments described herein enable a particularly good adaptation to the curvature of a windshield. This ensures particularly good and precise wiping of the windshield. Regions of the windshield which are not wiped and a formation of haze on the windshield can be substantially prevented. The structural configuration of the wiper lip described herein enables a substantially uniform pressing pressure of the wiper lip on the windshield so that a high wiping quality is provided and a noise, in particular when the movement direction of the wiper arm or the wiper blade is reversed in a turning position, is prevented or at least reduced.

1. A wiper lip (50) which is adapted to a windshield wiper device having a wiper blade (2) with an elongate upper portion (10) which is constructed to be at least partially bendable, an elongate lower portion (12) which is constructed to be at least partially bendable, a plurality of connection elements (18) for connecting the upper portion (10) and the lower portion (12), wherein the connection elements (18) are spaced apart from each other over a longitudinal extent (8) of the wiper blade (2), and wherein the connection elements (18) are configured to enable a movement of the upper portion (10) and the lower portion relative to each other with a movement component over a longitudinal extent (8) of the wiper blade (2), and wherein the windshield wiper device (100) is adapted to a vehicle, wherein a rigidity of the wiper lip is higher in a wiping direction than the rigidity of the wiper lip perpendicularly relative to the wiping direction (1).

2. The wiper lip (50) as claimed in claim 1, wherein the wiper lip (50) comprises a base region (21) and a wiper region (22), wherein the base region (21) is configured, when the wiper lip (50) comes into contact with a windshield and a spacing between the wiper blade (2) and the windshield is reduced, to provide a constant pressing force which acts substantially perpendicularly relative to the wiping direction (1).

3. The wiper lip (50) as claimed in claim 2, wherein the wiper region (22) has a pointed end (25) and a wide end (26), wherein a wiper edge (23) is arranged at the pointed end (25) of the wiper region (22), wherein the base region (21) of the wiper lip (50) is arranged at the wide end (26) of the wiper region (22), and wherein the base region (21) of the wiper lip (50) is wider than the wide end of the wiper region (22).

4. The wiper lip (50) as claimed in claim 2, wherein the base region (21) of the wiper lip (50) has a recess (24), wherein the recess (24) is arranged above a wide end of the wiper region (22).

5. The wiper lip (50) as claimed in claim 4, wherein a width of the recess (24) in the base region (21) of the wiper lip (20) is greater than a width of the wide end of the wiper region (22).

6. The wiper lip (50) as claimed in claim 2, wherein the wiper edge (23) comprises an angle of from 60° to 120°.

7. The wiper lip (50) as claimed in claim 4, wherein the recess (24) comprises a depth of from 1 mm to 3 mm.

8. The wiper lip (50) as claimed in claim 1, wherein the wiper lip (50) is of a material from the group comprising: TPE (thermoplastic elastomer), in particular TPE-S, TPE-O, TPE-U, TPE-A, TPE-V, TPE-E; ethylene-propylene-diene rubber (EPDM); polychloroprene and natural rubber.

9. The wiper lip (50) as claimed in claim 2, wherein the base region (21) is formed from a first material and the wiper region (22) is formed from a second material.

10. The wiper lip (50) as claimed in claim 1, wherein the wiper lip is produced by means of an extrusion method or an injection-molding method, in particular a dual component injection-molding method.

11. The wiper lip as claimed in claim 1, wherein adjacent to a face which is opposite the wiper edge perpendicularly relative to the wiping direction there is a gap or a hollow space.

12. The wiper lip (50) as claimed in claim 11, wherein the gap or the hollow space is unfilled or filled, in particular is filled with a gas, with a compressible medium or a resilient material.

13. The wiper lip (50) as claimed in claim 11, wherein the wiper edge (23) comprises an angle of from 60° to 120°, in particular 90°.

14. The wiper lip (50) as claimed in claim 11, wherein the wiper edge is of a material from the group comprising: TPE (thermoplastic elastomer), in particular TPE-S, TPE-O, TPE-U, TPE-A, TPE-V, TPE-E; ethylene-propylene-diene rubber (EPDM); polychloroprene and natural rubber.

15. A windshield wiping device (100) for a vehicle, comprising:
an elongate upper portion (10) which is constructed to be at least partially bendable,
an elongate lower portion (12) which is constructed to be at least partially bendable,
a plurality of connection elements (18) for connecting the upper portion (10) and the lower portion (12), wherein the connection elements (18) are spaced apart from each other over a longitudinal extent (8) of the wiper blade (2), and wherein the connection elements (18) are configured to enable a movement of the upper portion (10) and the lower portion relative to each other with a movement component over a longitudinal extent (8) of the wiper blade (2), and
a wiper lip (50) as claimed in claim 1.

16. The wiper lip (50) as claimed in claim 2, wherein the wiper edge (23) comprises an angle of 90°.

17. The wiper lip (50) as claimed in claim 1, wherein the wiper lip (50) is of a material from the group comprising: TPE-S, TPE-O, TPE-U, TPE-A, TPE-V, TPE-E, ethylene-propylene-diene rubber (EPDM), polychloroprene and natural rubber.

18. The wiper lip (50) as claimed in claim 1, wherein the wiper lip is produced by a dual component injection-molding method.

19. The wiper lip (50) as claimed in claim 11, wherein the gap or the hollow space is filled with a gas, with a compressible medium or a resilient material.

20. The wiper lip (50) as claimed in claim 11, wherein the wiper edge (23) comprises an angle of 90°.

21. The wiper lip (50) as claimed in claim 11, wherein the wiper edge is of a material from the group comprising: TPE-S, TPE-O, TPE-U, TPE-A, TPE-V, TPE-E, ethylene-propylene-diene rubber (EPDM), polychloroprene and natural rubber.
